(19) United States
(12) Patent Application Publication
(10) Pub. No.: US 2026/0141345 A1
(43) Pub. Date: May 21, 2026

(54) STOCK MANAGEMENT DEVICE, STOCK MANAGEMENT METHOD, AND RECORDING MEDIUM

(71) Applicant: NEC Corporation, Tokyo (JP)

(72) Inventor: Wataru TAKIOKA, Tokyo (JP)

(73) Assignee: NEC Corporation, Tokyo (JP)

(21) Appl. No.: 19/360,125

(22) Filed: Oct. 16, 2025

(30) Foreign Application Priority Data
Nov. 15, 2024 (JP) 2024-199408

(51) Int. Cl. G06Q 10/087; G06K 7/10; G06V 20/52

(52) U.S. Cl. CPC G06Q 10/08724; G06V 20/52; G06K 7/10297

(57) ABSTRACT

A stock management device includes: one or more memories storing instructions; and one or more processors configured to execute the instructions to: acquire first reading information of a radio tag attached to a product, read by a first reading device provided between a backyard of a store and a sales floor of the store and an image obtained by imaging a product shelf of the sales floor; specify the number of stocks in the sales floor, based on the number of stocked products specified from the first reading information and the number of taken-out products specified from the image; and output the number of stocks in the sales floor.

This application is based upon and claims the benefit of priority from Japanese Patent Application No. 2024-199408, filed on Nov. 15, 2024, the disclosure of which is incorporated herein in its entirety by reference.

### TECHNICAL FIELD

The present disclosure relates to a stock management device, a stock management method, and a recording medium.

### BACKGROUND ART

JP 2023-093830 A describes a stock management device that manages goods in a storage, based on goods information acquired by communicating with a radio tag, via a loading antenna and an unloading antenna provided in such a way as to communicate with the radio tag attached to the goods housed in the storage.

### SUMMARY

An example of an object of the present disclosure is to provide a stock management technology that can be introduced at low cost.

A stock management device according to one aspect of the present disclosure includes acquisition means for acquiring first reading information of a radio tag attached to a product, read by a first reading device provided between a backyard of a store and a sales floor of the store and an image obtained by imaging a product shelf of the sales floor, specification means for specifying the number of stocks in the sales floor, based on the number of stocked products specified from the first reading information and the number of taken-out products specified from the image, and output means for outputting the number of stocks in the sales floor.

A stock management method according to one aspect of the present disclosure includes acquiring first reading information of a radio tag attached to a product, read by a first reading device provided between a backyard of a store and a sales floor of the store and an image obtained by imaging a product shelf of the sales floor, specifying the number of stocks in the sales floor, based on the number of stocked products specified from the first reading information and the number of taken-out products specified from the image, and outputting the number of stocks in the sales floor.

A program according to one aspect of the present disclosure causes a computer to execute processing including acquiring first reading information of a radio tag attached to a product, read by a first reading device provided between a backyard of a store and a sales floor of the store and an image obtained by imaging a product shelf of the sales floor, specifying the number of stocks in the sales floor, based on the number of stocked products specified from the first reading information and the number of taken-out products specified from the image, and outputting the number of stocks in the sales floor.

Each program may be stored in a non-transitory computer-readable recording medium.

### BRIEF DESCRIPTION OF THE DRAWINGS

FIG. 1 is a diagram illustrating a configuration of a system including a stock management device;

FIG. 2 is a block diagram illustrating a functional configuration of the stock management device;

FIG. 3 is a flowchart illustrating an operation of the stock management device;

FIG. 4 is a block diagram illustrating another example of the functional configuration of the stock management device;

FIG. 5 is a flowchart illustrating an operation of the stock management device;

FIG. 6 is a block diagram illustrating still another example of the functional configuration of the stock management device;

FIG. 7 is a flowchart illustrating an operation of the stock management device; and

FIG. 8 is a diagram illustrating a hardware configuration in which the stock management device according to the present disclosure is achieved by a computer and its peripheral devices.

### EXAMPLE EMBODIMENT

Hereinafter, example embodiments of the present disclosure will be described in detail with reference to the drawings.

### First Example Embodiment

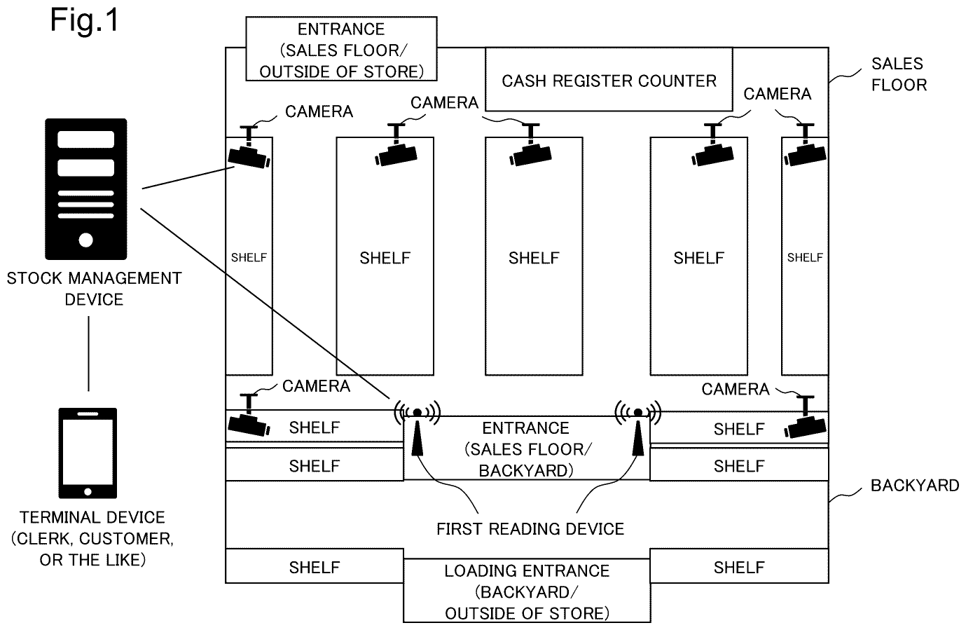

FIG. 1 is a diagram illustrating an example of a system including a stock management device according to the present disclosure.

In FIG. 1, a stock management device 100 is a device that manages a stock of a product in a store. The stock management device 100 manages at least the number of stocks of the products. The stock management device 100 may manage a position where the stock of the product is placed, as described in a second example embodiment to be described later. For example, the stock management device 100 is achieved by a server or a cloud computing system.

The stock management device 100 is communicably connected to a terminal device, a camera, and a reading device, in the system illustrated in FIG. 1. Although not illustrated in FIG. 1, the stock management device 100 is communicably connected to the plurality of cameras and the plurality of reading devices installed in the store. Installation positions, the number, and the like of the cameras and the reading devices installed in the store are not limited to the example in FIG. 1.

The terminal device is a device that outputs information output by the stock management device 100 as display, sound, or the like. The terminal device is, for example, a terminal device used by a customer or an employee of the store. The terminal device is achieved, for example, by a smartphone, a tablet, a Personal Computer (PC), a dedicated terminal device used for stock management, or the like. The number of terminal devices communicably connected to the stock management device 100 may be plural.

The camera is a camera that images a product shelf of a sales floor. The camera is installed in such a way as to be capable of imaging an operation for taking out a product by the customer or a clerk, in the store. Here, the camera may be fixed to a wall, a ceiling, the product shelf, or the like of the store or may be movable. The number of cameras may be plural.

The reading device is a reading device that reads information recorded in a radio tag, by communicating with the radio tag attached to the product. The reading device is, for example, a Radio Frequency Identification (RFID) reader, and the radio tag is, for example, a RFID tag. The number of reading devices may be one or plural.

In FIG. 1, the reading device is installed at an entrance between the sales floor of the store and a backyard and reads the radio tag attached to the product that moves between the sales floor and the backyard. In this case, for example, the reading device may be included in a gate provided at the entrance.

The reading device installed at the entrance between the backyard and the sales floor reads a radio tag of a product moving from the backyard to the sales floor and a radio tag of a product moving from the sales floor to the backyard.

The reading device may be further installed on a shelf, a wall, a ceiling, or the like in the backyard, in such a way as to read a radio tag attached to a product in the backyard. The reading device in this case can be used to grasp the number and positions of the products placed in the backyard. The reading device may be installed at a loading entrance between the backyard and outside of the store, in such a way as to read a radio tag attached to a product arrived at the store.

Next, a configuration of the stock management device 100 according to the example embodiment will be described.

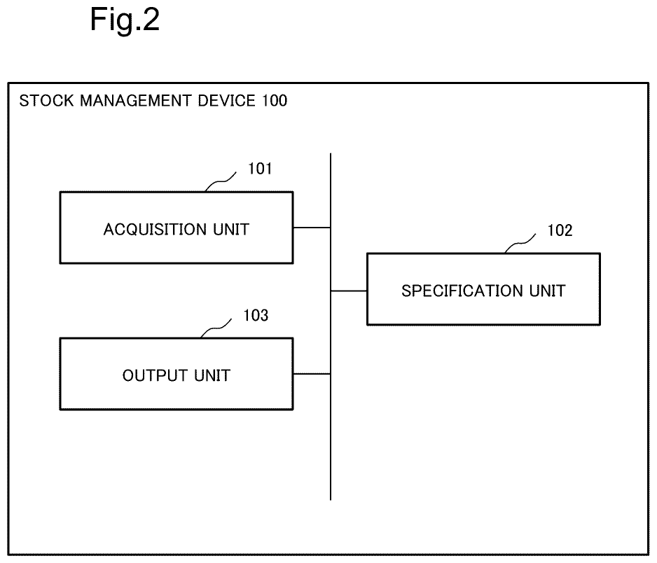

FIG. 2 is a block diagram illustrating the configuration of the stock management device 100. Referring to FIG. 2, the stock management device 100 includes an acquisition unit 101, a specification unit 102, and an output unit 103.

Next, the configuration of the stock management device 100 will be described in detail. The stock management device 100 specifies and outputs the number of stocks in the sales floor of the store.

The acquisition unit 101 is an example of acquisition means for acquiring first reading information of a radio tag attached to a product, read by a first reading device provided between the backyard of the store and the sales floor of the store and an image obtained by imaging the product shelf of the sales floor. For example, the acquisition unit 101 acquires the first reading information from the first reading device and acquires the image from the camera.

That is, the acquisition unit 101 acquires the first reading information of the radio tag attached to the product moving between the sales floor and the backyard. Here, the first reading information includes reading information of the radio tag attached to the product moving from the backyard to the sales floor and reading information of the radio tag attached to the product moving from the sales floor to the backyard.

The acquisition unit 101 acquires an image obtained by imaging an operation of the customer or the clerk for taking out a product from the product shelf of the sales floor. Here, the product shelf is a product shelf installed on the sales floor in the store. The product shelf may include all product shelves installed on the sales floor in the store or may be some product shelves, on which products to be stock management targets are displayed. The acquisition unit 101 may acquire an image obtained by imaging an operation of the customer or the clerk for displaying products on the product shelf of the sales floor.

Here, the acquisition unit 101 may acquire information regarding stocks of all the products in the store or may acquire information regarding stocks of some products in the store. For example, the acquisition unit 101 may acquire information regarding a stock of a product for which it is more desired to accurately grasp the stock, among the products in the store. The product for which it is desired to more accurately grasp the stock is, for example, an expensive product or a popular product of which a stock is likely to be inquired. Here, the information regarding the stock of the product is, for example, the first reading information described above or the image obtained by imaging the product shelf of the sales floor.

The specification unit 102 is an example of specification means for specifying the number of stocks in the sales floor, based on the number of stocked products specified from the first reading information and the number of taken-out products specified from the image. For example, the specification unit 102 may specify the number of stocks in the sales floor, by adding the number of stocked products to the number of stocks in the sales floor stored in a storage unit (not illustrated) in advance and subtracting the number of taken-out products.

A known method may be used to specify the number of stocked products and specify the number of taken-out products. The specification unit 102 or a specification device provided inside or outside the stock management device 100 may specify the number of stocked products and the number of taken-out products.

An example of processing for specifying the number of stocked products, based on the first reading information, by the specification unit 102 will be described. For example, the specification unit 102 specifies product identification information from the first reading information. The product identification information is information used to identify a product. Then, the specification unit 102 specifies the number of stocked products, by counting the number of products included in the first reading information, for each product, using the product identification information.

Here, the number of stocked products is specified based on the first reading information. Therefore, the number of stocked products is the number of products that have moved from the backyard to the sales floor, that is, the number of stocked products. The number of products that have moved from the sales floor to the backyard may be specified as a negative (minus) number of stocked products. For example, this is because it is considered that the product is moved from the sales floor to the backyard due to a change in the number of displays on the product shelf in the sales floor, an expiration of a sell-by date of the product, or the like. The first reading information may include only product identification information of the product that has moved from the backyard to the sales floor, or may identifiably include each of the product identification information of the product that has moved from the backyard to the sales floor and product identification information of the product that has moved from the sales floor to the backyard. That is, the first reading device may read a radio tag attached to the product that has moved from the backyard to the sales floor or may identify and read a radio tag attached to the product that has moved from the backyard to the sales floor and a radio tag attached to the product that has moved from the sales floor to the backyard. A known method may be used for such reading of the radio tag according to the moving direction. A second reading device and a third reading device to be described later may similarly read the radio tag according to the moving direction.

An example of processing for specifying the number of taken-out products, based on the image obtained by imaging the product shelf of the sales floor by the specification unit 102 will be described. For example, the specification unit 102 specifies the number of displays for each product displayed on the product shelf, by executing image recognition processing on the image obtained by imaging the product shelf of the sales floor. Next, the specification unit 102 specifies a decrease in the number of displayed products specified from the image, as the number of taken-out products. A known technique may be used for the image recognition processing.

For example, the specification unit 102 specifies an operation of a person who takes out the product displayed on the product shelf, by executing the image recognition processing on the image obtained by imaging the product shelf of the sales floor. Next, the specification unit 102 identifies a product held in a person's hand, in an image in which the operation of the person who takes out the product from the product shelf is specified or an image after a predetermined time from when the operation of the person who takes out the product from the product shelf is specified. Next, the specification unit 102 specifies the number of taken-out products, by counting the number of identified products as the number of taken-out products.

The number of taken-out products is specified based on the image obtained by imaging the product shelf of the sales floor. Therefore, the number of taken-out products is the number of products taken out from the product shelf. Among the number of products displayed on the product shelf, the number of displayed products other than the products that have moved from the backyard to the sales floor may be specified as a negative (minus) number of taken-out products. Here, among the number of products displayed on the product shelf, the number of displayed products other than the product that has moved from the backyard to the sales floor is the number of products that are taken out from the product shelf once and displayed on the product shelf again (the number of products returned to the product shelf). The number of products returned to the product shelf may be specified similarly to the number of taken-out products. For example, among the number of products displayed on the product shelf, the number of displayed products other than the products that have moved from the backyard to the sales floor may be specified by tracking the product in the image obtained by imaging the sales floor of the store. A product that has been taken out from the product shelf once and displayed on the product shelf again may be specified by specifying that a product other than a product that is specified to be stocked is displayed based on the first reading information.

The output unit 103 is an example of output means for outputting the number of stocks in the sales floor. The output unit 103 outputs the number of stocks in the sales floor to the terminal device. An output mode by the output unit 103 is not particularly limited. For example, the output unit 103 may output a list of the numbers of stocks of all the products in the sales floor or may output the number of stocks of products or products included in a product category, requested from the terminal device.

The output unit 103 may output the number of stocks in the sales floor, to a database that manages information regarding products to be sold in the store.

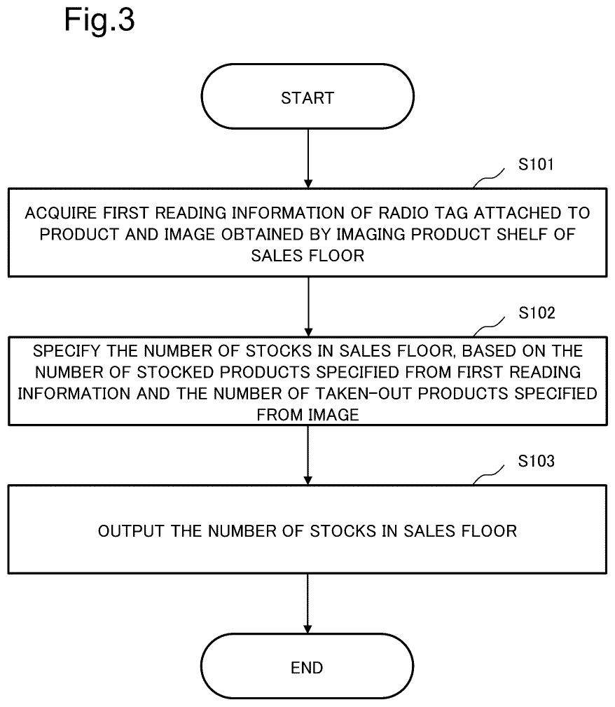

An operation of the stock management device 100 configured as described above will be described with reference to the flowchart in FIG. 3.

First, the acquisition unit 101 acquires the first reading information of the radio tag attached to the product and the image obtained by imaging the product shelf of the sales floor (step S101).

Next, the specification unit 102 specifies the number of stocks in the sales floor, based on the number of stocked products specified from the first reading information acquired in step S101 and the number of taken-out products specified from the image acquired in step S101 (step S102).

Next, the output unit 103 outputs the number of stocks in the sales floor specified in step S102 (step S103).

As described above, the stock management device 100 ends the series of operations.

The stock management device 100 described above includes the acquisition unit 101, the specification unit 102, and the output unit 103. The acquisition unit 101 acquires the first reading information of the radio tag, attached to the product, read by the first reading device provided between the backyard of the store and the sales floor of the store and the image obtained by imaging the product shelf of the sales floor. The specification unit 102 specifies the number of stocks in the sales floor, based on the number of stocked products specified from the first reading information and the number of taken-out products specified from the image. The output unit 103 outputs the number of stocks in the sales floor.

The stock management device 100 specifies and outputs the number of stocks in the sales floor, using the first reading information of the radio tag read by the first reading device provided between the backyard and the sales floor and the image of the product shelf of the sales floor imaged by the camera provided on the sales floor. Therefore, with the stock management device 100, the clerk and the customer can know the number of stocks in the sales floor of the store, without installing the reading device on the sales floor of the store. As a result, the stock management device 100 can provide a stock management technology that can be provided at low cost.

For example, to install the reading device, there is a case where it is necessary to respond to a technician, to change a material of furniture and fixtures such as the product shelf to a different material, so as not to interfere with a radio wave used for reading by the reading device, or to change a layout of the furniture and fixtures such as the product shelf. According to the stock management device 100, since the number of stocks in the sales floor of the store is specified and output without requiring the installation of such a reading device, on the sales floor of the store, the stock management device 100 can provide the stock management technology that can be provided at low cost.

There is a technique for managing stocks of products, in a warehouse or a store. For example, there is a technique for attaching a radio tag to a product and managing a stock using information read from the radio tag using an antenna installed in a warehouse or a store.

However, in a case where product stock management is performed using communication between a radio tag and an antenna, there is a case where radio waves interfere, depending on a material of a shelf where the product is placed. Therefore, in a case where a system that performs the product stock management using the communication between the radio tag and the antenna is introduced, it may be necessary to replace the shelf with a shelf made of a material that does not interfere with the radio waves.

An example of effects of the present disclosure is that it is possible to provide a stock management technology that can be introduced at low cost.

### Second Example Embodiment

Next, a second example embodiment of the present disclosure will be described in detail with reference to the drawings. Hereinafter, the description of content overlapping with the above description will be omitted to the extent that description of the present example embodiment is not unclear.

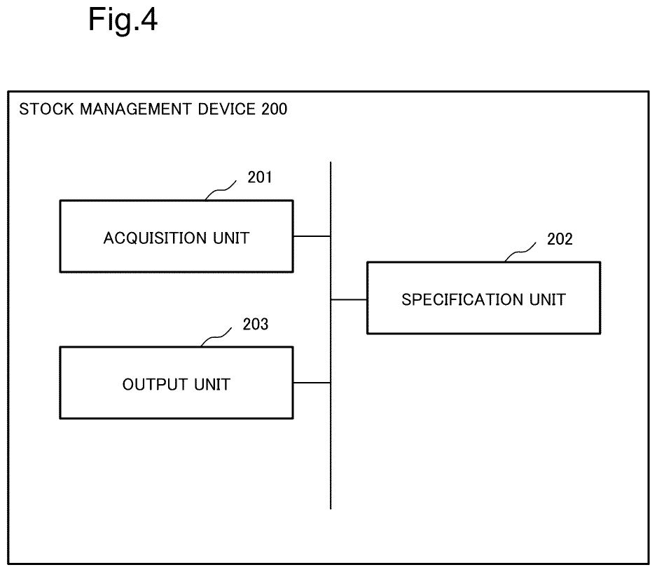

FIG. 4 is a block diagram illustrating a configuration of a stock management device. In FIG. 4, a stock management device 200 includes an acquisition unit 201, a specification unit 202, and an output unit 203, instead of the configuration of the stock management device 100.

Next, a configuration of the stock management device 200 will be described in detail. The stock management device 200 specifies and outputs at least one of the number of stocks in a backyard, the number of lost products, and the number of arrived products, in addition to the number of stock in a sales floor of a store. That is, the acquisition unit 201, the specification unit 202, and the output unit 203 respectively have functions of the acquisition unit 101, the specification unit 102, and the output unit 103.

The acquisition unit 201 appropriately acquires information regarding the stock of the product, according to content specified by the specification unit 202.

For example, in a case where the specification unit 202 specifies the number of lost products, the acquisition unit 201 may acquire a sales volume of the product. Here, the number of lost products is the number of products that have been taken out from a product shelf in the sales floor but have not been paid. Although the acquisition unit 201 may acquire the sales volume of the product, for example, from a Point of Sales (POS) device used in the store or a POS server, an acquisition source of the sales volume of the product is not limited to these examples.

For example, in a case where the specification unit 202 specifies the number of stocks in the backyard, the acquisition unit 201 acquires second reading information of a radio tag, read by a second reading device provided in the backyard. The second reading device is installed in such a way as to communicate with a radio tag attached to a product in the backyard.

For example, in a case where the specification unit 202 specifies the number of stocks in the backyard, the acquisition unit 201 may acquire the number of arrived products. For example, the acquisition unit 201 acquires the number of arrived products from a system that places an order for products, a database that manages information regarding products to be sold in the store, or the like.

For example, in a case where the specification unit 202 specifies the number of stocks in the backyard or the number of arrived products, the acquisition unit 201 may acquire third reading information of a radio tag, read by a third reading device provided at a loading entrance between the backyard and outside the store. The third reading device is installed in such a way as to communicate with a radio tag attached to a product that moves between the backyard and outside of the store.

The acquisition unit 201 may acquire one or a plurality of pieces of information among the plurality of pieces of information regarding the stock of the product. The acquisition unit 201 may acquire information regarding stocks of all the products in the store or may acquire information regarding stocks of some products in the store, as in the first example embodiment. For example, the acquisition unit 201 may acquire information regarding a stock of a product for which it is desired to more accurately grasp the stock, such as an expensive product, among the products in the store. Here, the information regarding the stock of the product is, for example, the sales volume of the product, the second reading information, the number of arrived products, the third reading information, or the like, in addition to the first reading information and the image obtained by imaging the product shelf of the sales floor described above.

The specification unit 202 specifies at least one of the number of stocks in the backyard, the number of lost products, and the number of arrived products.

For example, the specification unit 202 further specifies the number of lost products, based on the sales volume of the product and the number of taken-out products. For example, the specification unit 202 may specify the number of lost products, by subtracting the sales volume of the product from the number of taken-out products.

The specification unit 202 may specify the number of lost products, based on the sales volume of the product and the number of taken-out products specified based on an image for which a predetermined time has elapsed after being imaged. The predetermined time will be described later. In a case where a customer purchases a product in the store, it is assumed to take time to purchase other products, consider whether to purchase the product, movement, or the like, from a time when the customer takes out the product from the product shelf of the sales floor to a time when sales of the product are recorded. Therefore, since the specification unit 202 does not include the number of products to be purchased by the customer in the number of lost products, by specifying the number of lost products, based on the number of taken-out products specified based on the sales volume of the product and the image for which the predetermined time has elapsed after being imaged, the specification unit 202 can more accurately specify the number of lost products.

Here, as the predetermined time regarding the specification of the number of lost products, it is sufficient to appropriately set a time assumed to be required until the sales of the product are recorded after the customer takes out the product from the product shelf of the sales floor. Being recorded as the sales of the product is, for example, making payment for the product using the POS device.

The predetermined time regarding the specification of the number of lost products may be set for each product, for each product category, or for each product shelf. This is because there is a possibility that a time before purchase of the product differs for each product or product category, for example, in a product category in which a variety of products are included or a large number of products in the same category are displayed, it is assumed that a period of time when the customer selects a product becomes longer. For example, this is because there is a possibility that a time required for moving to a cash register counter differs, depending on a position of the product shelf in the sales floor of the store. Therefore, there is a case where the number of lost products can be more accurately specified, by setting the predetermined time regarding the specification of the number of lost products, for each product, for each product category, or for each product shelf.

For example, the specification unit 202 may specify the number of arrived products, based on the third reading information. For example, the specification unit 202 specifies product identification information from the third reading information. The product identification information is information used to identify a product, as described above. Then, the specification unit 202 specifies the number of arrived products, by counting the number of products for each product included in the third reading information, using the product identification information.

Here, the number of arrived products is specified based on the third reading information. Therefore, the number of arrived products in this case is the number of products moved from outside of the store to inside of the store. The number of products moved from the backyard of the store to the outside of the store may be specified as a negative (minus) number of arrived products. For example, this is because it is considered that the product is moved from the backyard to the outside of the store, because the product is discarded, returned, or the like.

For example, the specification unit 202 may further specify the number of stocks in the backyard. For example, the specification unit 202 further specifies the number of stocks in the backyard, based on the number of arrived products and the number of stocked products. For example, the specification unit 202 may specify the number of stocks in the backyard, by adding the number of arrived products to the latest number of stocks specified or acquired and subtracting the number of stocked products. In this case, the number of arrived products may be specified by the specification unit 202 or acquired by the acquisition unit 201.

For example, the specification unit 202 may further specify the number of stocks in the backyard, based on the second reading information. For example, the specification unit 202 specifies the product identification information from the second reading information. Then, the specification unit 202 specifies the number of stocks in the backyard, by counting the number of products included in the second reading information for each product, using the product identification information.

The output unit 203 outputs at least one of the number of stocks in the backyard, the number of lost products, and the number of arrived products, specified by the specification unit 202. For example, the output unit 203 may perform the output described above, to the terminal device, the database that manages the information regarding the product to be sold in the store, or the like.

The output unit 203 may vary content to be output, according to a user of the terminal device. For example, the output unit 203 may output more types of content, to a terminal device used by an employee of the store, than a terminal device used by the customer of the store. For example, the output unit 203 may output the number of stocks in the sales floor, to the terminal device used by the customer of the store and output the number of stocks in the sales floor, the number of lost products, and the number of stocks in the backyard, to the terminal device used by the employee of the store. The example in which the output unit 203 varies the content to be output depending on the user of the terminal device is not limited to this example. In this case, the output unit 203 may perform appropriate output to the user of the terminal device, using information in which identification information of the user and identification information of the terminal device are associated, information in which information indicating whether the user is the clerk or the customer and the identification information of the terminal device are associated, or the like. A method for performing the output by the output unit 203 depending on the user of the terminal device is not limited to this example, and a known technique may be used.

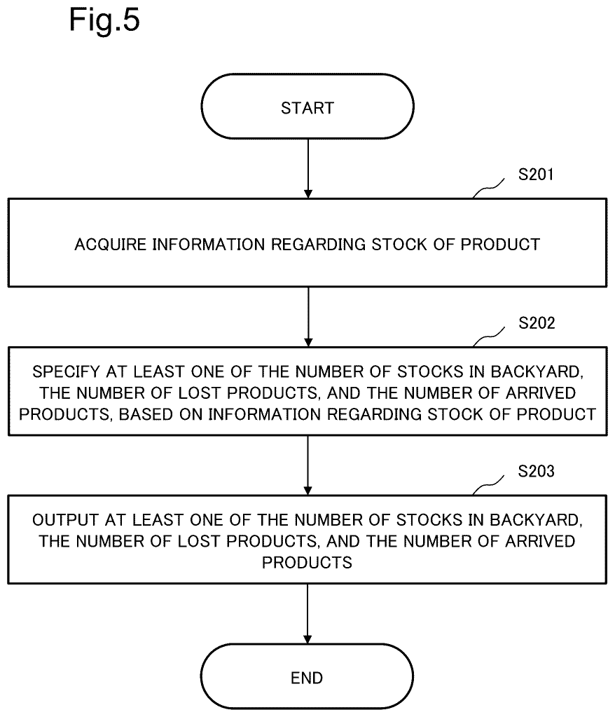

An operation of the stock management device 200 configured as described above will be described with reference to the flowchart in FIG. 5.

First, the acquisition unit 201 acquires the information regarding the stock of the product (step S201).

Next, the specification unit 202 specifies at least one of the number of stocks in the backyard, the number of lost products, and the number of arrived products, based on the information regarding the stock of the product acquired in step S201 (step S202). In step S202, the specification unit 202 may specify one of the number of stocks in the backyard, the number of lost products, and the number of arrived products, that can be specified using the information of the type acquired by the acquisition unit 201.

Next, the output unit 203 outputs at least one of the number of stocks in the backyard, the number of lost products, and the number of arrived products specified in step S202 (step S203).

As described above, the stock management device 200 ends the series of operations.

The stock management device 200 in the present example embodiment described above includes the acquisition unit 201, the specification unit 202, and the output unit 203. The acquisition unit 201 acquires the information regarding the stock of the product, in addition to the function of the acquisition unit 101. The specification unit 202 specifies at least one of the number of stocks in the backyard, the number of lost products, and the number of arrived products, based on the information regarding the stock of the product, in addition to the function of the specification unit 102. The output unit 203 outputs at least one of the number of stocks in the backyard, the number of lost products, and the number of arrived products, based on the information regarding the stock of the product, in addition to the function of the output unit 103.

As a result, the stock management device 200 according to the present example embodiment can provide a stock management technology that can be introduced at low cost.

For example, since the stock management device 200 according to the present example embodiment specifies and outputs at least one of the number of stocks in the backyard, the number of lost products, and the number of arrived products, it is possible to assist stock management.

### First Modification

Next, a first modification of the present disclosure will be described in detail with reference to the drawings. Hereinafter, the description of content overlapping with the above description will be omitted to the extent that description of the present modification is not unclear.

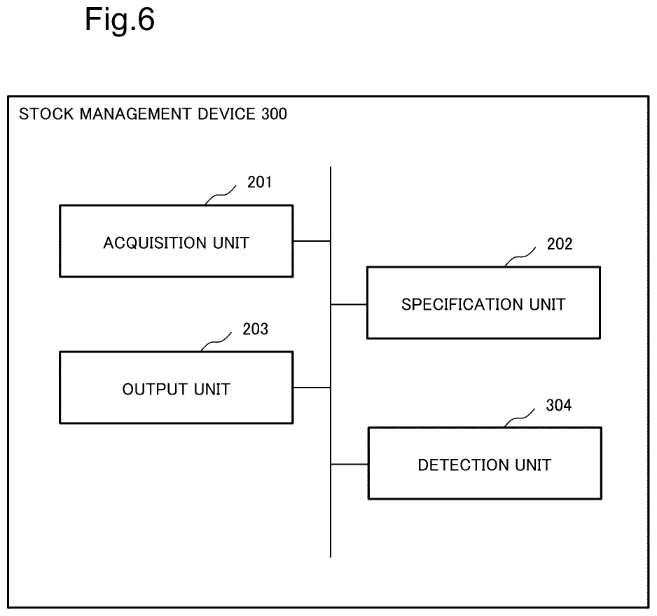

FIG. 6 is a block diagram illustrating a configuration of a stock management device 300. In FIG. 6, the stock management device 300 includes a detection unit 304, in addition to the configuration of the stock management device 200. The detection unit 304 may be further included in the stock management device 100.

The detection unit 304 is an example of detection means for detecting a location of a product, at a timing according to a timing when the number of stocks changes. The location of the product is a place where the product is stored. A method for detecting the location of the product may be a known method using the image or the reading information of the radio tag.

The timing when the number of stocks changes is at least one of a timing when the number of stocks in the sales floor changes and a timing when the number of stocks in the backyard changes.

For example, a timing when the radio tag is read by the first reading device is the timing when the number of stocks in the sales floor changes and the timing when the number of stocks in the backyard changes. The timing when the radio tag is read by the first reading device may be a timing when the acquisition unit 201 acquires the first reading information.

For example, a timing when the radio tag is read by the third reading device is the timing when the number of stocks in the backyard changes. The timing when the radio tag is read by the third reading device may be a timing when the acquisition unit 201 acquires the third reading information. For example, a timing when the product is taken out from the product shelf is the timing when the number of stocks in the sales floor changes.

The timing when the number of stocks changes may be a timing when the change is specified by comparing the number of stocks in the sales floor or the number of stocks in the backyard specified by the specification unit 202 and the immediately preceding number of stocks in the sales floor or the immediately preceding number of stocks in the backyard.

That is, the detection unit 304 may detect at least one of the location of the product in the sales floor of the store and the location of the product in the backyard of the store, at the timing according to the timing when the number of stocks in the sales floor changes. The detection unit 304 may detect the location of the product in the backyard of the store, at the timing according to the timing when the number of stocks in the backyard changes.

The timing when the number of stocks changes may be detected by the detection unit 304 or may be detected by another detection device or means, provided inside or outside the stock management device 300, which detects the timing when the number of stocks changes.

The timing according to the timing when the number of stocks changes may be the timing when the number of stocks changes or may be a timing when a predetermined time has elapsed from the timing when the number of stocks changes.

Here, as the predetermined time, it is sufficient to appropriately set a time considering that there is a difference between a timing when the change in the number of stocks can be specified and a timing when a product storage place is determined. For example, in a case where the product is stocked from the backyard to the sales floor, it is assumed that a time for movement or the like is required, before the product is displayed, after the radio tag is read by the first reading device.

The predetermined time may be set, for example, according to a change amount of the number of stocks. In a case where the change amount of the number of stocks is large because the number of stocked products or the number of arrived products is large, it can be assumed that the clerk stock or receive the products while moving many products at a time. Therefore, in this case, since there is an increasing possibility that a time taken before the product to be stocked or received is moved to the storage place increases, by setting the predetermined time according to the change amount of the number of stocks, there is a possibility that the location of the product can be detected at a more appropriate timing.

The output unit 203 may output the location detected by the detection unit 304 to the terminal device, the database, or the like.

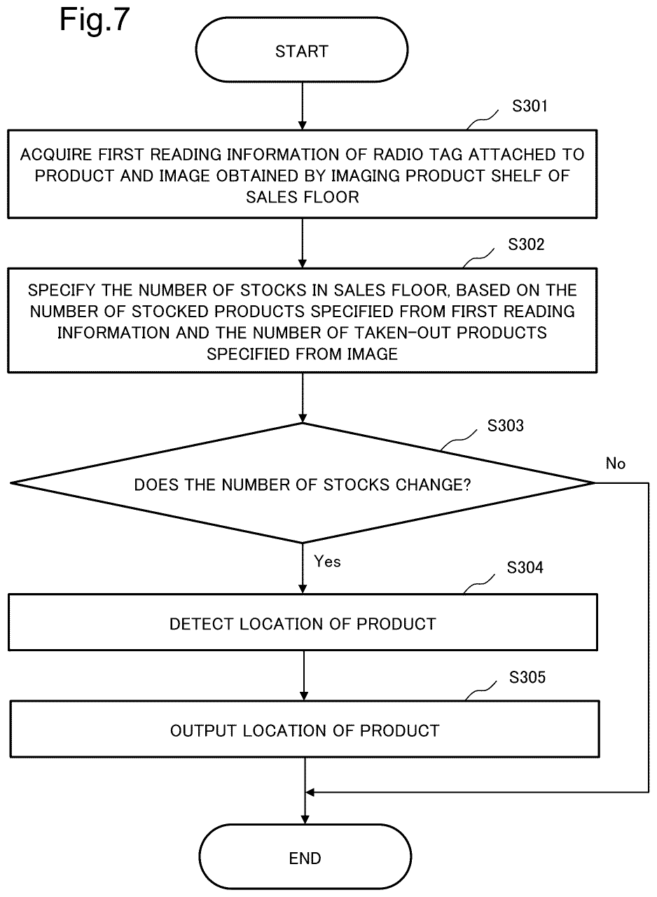

An example of an operation of the stock management device 300 configured as described above will be described with reference to the flowchart in FIG. 7.

The acquisition unit 201 acquires the first reading information of the radio tag attached to the product and the image obtained by imaging the product shelf of the sales floor (step S301). The acquisition unit 201 may acquire other pieces of information described in the second example embodiment.

Next, the specification unit 202 specifies the number of stocks in the sales floor, based on the number of stocked products specified from the first reading information and the number of taken-out products specified from the image (step S302). The specification unit 202 may specify the other pieces of information described in the second example embodiment.

Next, the detection unit 304 detects whether the number of stocks changes (step S303). In a case where it is not detected in step S303 that the number of stocks changes (step S303: No), the series of operations of the stock management device 300 ends.

In a case where it is detected in step S303 that the number of stocks changes (step S303; Yes), the detection unit 304 detects the location of the product (step S304).

Then, the output unit 203 outputs the location of the product detected in step S304 (step S305).

As described above, the stock management device 300 ends the series of operations.

The stock management device 300 can detect the location of the product at an appropriate timing according to a situation of the store, by detecting the location of the product, at the timing according to the timing when the number of stocks changes.

### Second Modification

Next, a second modification of the present disclosure will be described in detail with reference to the drawings. Hereinafter, the description of content overlapping with the above description will be omitted to the extent that description of the present modification is not unclear.

The present modification is a modification of the stock management device 200.

In the stock management device 200, the specification unit 202 specifies the number of stocks in the backyard, based on each of the number of arrived products, the number of stocked products, and the second reading information.

In a case where the numbers of stocks in the backyard specified based on the different pieces of information do not match, the output unit 203 may output an alert. An output destination and an output mode of the alert are not particularly limited. For example, the alert may include information in which information used to specify the number of stocks in the backyard and the number of stocks in the backyard specified based on the information are associated.

In a case where the numbers of stocks in the backyard specified based on the different pieces of information do not match, an illegal act performed on the product by the person, or occurrence of a malfunction in the reading device that reads the radio tag, the camera that images the image, communication of the stock management device 200, or the like is assumed. Therefore, in this case, there is a possibility that the employee or the like of the store can easily cope with the illegal act or the malfunction described above, by outputting the alert by the output unit 203.

### Hardware Configuration

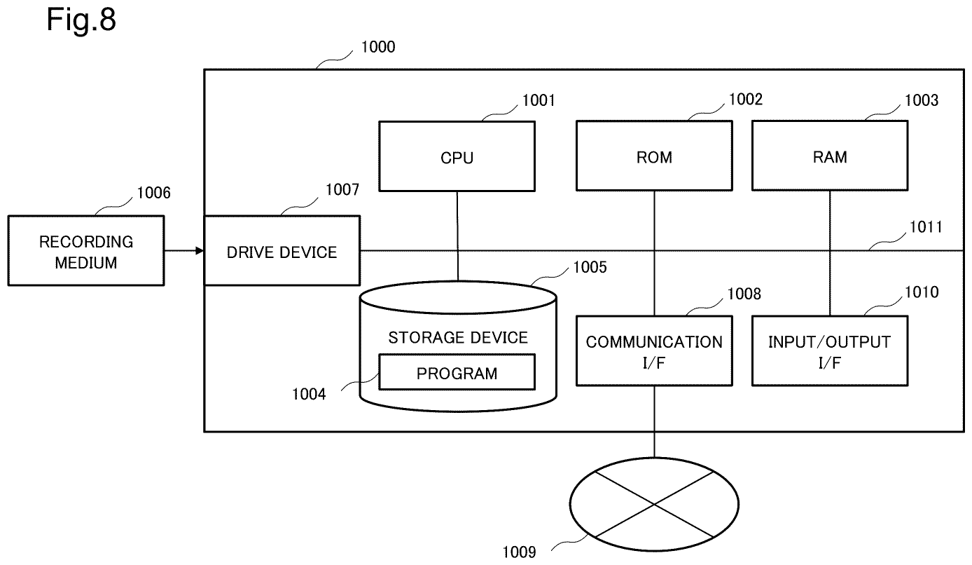

Some or all of the components of each device or system in each example embodiment of the present disclosure described above are achieved by, for example, any combination of an information processing apparatus 1000 and a program as illustrated in FIG. 8. As an example, the information processing apparatus 1000 includes the following components.
Central Processing Unit (CPU) 1001
Read Only Memory (ROM) 1002
Random Access Memory (RAM) 1003
A program 1004 loaded into the RAM 1003
A storage device 1005 storing the program 1004
A drive device 1007 for reading/writing a recording medium 1006
A communication I/F 1008 connected to a communication network 1009
An input/output I/F 1010 for inputting/outputting data
A bus 1011 connecting each component
I/F is an abbreviation of Interface.

Each component of each apparatus or system in each example embodiment is achieved by the CPU 1001 acquiring and executing a program for achieving these functions. The program for achieving the function of each component of each apparatus is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the method for achieving each apparatus. For example, each apparatus or system may be achieved by any combination of the information processing apparatus 1000 and the program separate for each component. A plurality of components included in each apparatus may be achieved by any combination of one information processing apparatus 1000 and the program.

Some or all of the components of each apparatus or system are achieved by a general-purpose or dedicated circuitry including a processor or the like, or a combination thereof. The circuitry is, for example, a CPU, a Graphics Processing Unit (GPU), a Field Programmable Gate Array (FPGA), or a Large Scale Integration (LSI) for Artificial Intelligence (AI) processing. These may be configured by a single chip or may be configured by a plurality of chips connected via a bus. Some or all of the components of each apparatus may be achieved by a combination of the above-described circuitry and the like and the program.

In a case where some or all of the components of each apparatus or system are achieved by a plurality of the information processing apparatuses, circuitry, and the like, the plurality of information processing apparatuses, circuitry, and the like may be arranged in a centralized manner or in a distributed manner. For example, each of the information processing apparatuses, circuitry, or the like may be achieved in the form of a client server system, a cloud computing system, or the like in which they are connected to each other through a communication network.

While the present disclosure has been particularly shown and described with reference to each of the example embodiments thereof, the present disclosure is not limited to these example embodiments. It will be understood by those of ordinary skill in the art that various changes in form and details may be made therein without departing from the spirit and scope of the present disclosure as defined by the claims.

Although a plurality of operations is described in order in the form of a flowchart, the order of description does not limit the order of executing the plurality of operations. Therefore, when each example embodiment is implemented, the order of the plurality of operations may be changed within a range that does not interfere with the content.

Some or all of the above-described example embodiments may be described as the following supplementary notes, but are not limited to the following.

### Supplementary Note 1

A stock management device including:
acquisition means for acquiring first reading information of a radio tag attached to a product, read by a first reading device provided between a backyard of a store and a sales floor of the store and an image obtained by imaging a product shelf of the sales floor;
specification means for specifying the number of stocks in the sales floor, based on the number of stocked products specified from the first reading information and the number of taken-out products specified from the image; and
output means for outputting the number of stocks in the sales floor.

### Supplementary Note 2

The stock management device according to supplementary note 1, in which
the specification means further specifies the number of lost products, based on a sales volume of the product and the number of taken-out products.

### Supplementary Note 3

The stock management device according to supplementary note 2, in which
the specification means specifies the number of lost products, based on the sales volume and the number of taken-out products specified based on the image for which a predetermined time or longer has elapsed after being captured.

### Supplementary Note 4

The stock management device according to supplementary note 2 or 3, in which
the output means outputs the number of lost products, to a terminal device used by an employee of the store.

### Supplementary Note 5

The stock management device according to any one of supplementary notes 1 to 4, in which
the specification means further specifies the number of stocks in the backyard, based on the number of arrived products and the number of stocked products.

### Supplementary Note 6

The stock management device according to any one of supplementary notes 1 to 5, in which
the acquisition means acquires third reading information of the radio tag, read by a third reading device provided at a loading entrance between the backyard and outside of the store, and
the specification means specifies the number of arrived products, based on the third reading information.

### Supplementary Note 7

The stock management device according to any one of supplementary notes 1 to 6, in which
the acquisition means acquires second reading information of the radio tag, read by a second reading device provided in the backyard, and
the specification means further specifies the number of stocks in the backyard, based on the second reading information.

### Supplementary Note 8

The stock management device according to any one of supplementary notes 1 to 7, further including:
detection means for detecting a location of the product, at a timing according to a timing when the number of stocks in the sales floor changes.

### Supplementary Note 9

A stock management method including:
acquiring first reading information of a radio tag attached to a product, read by a first reading device provided between a backyard of a store and a sales floor of the store and an image obtained by imaging a product shelf of the sales floor;
specifying the number of stocks in the sales floor, based on the number of stocked products specified from the first reading information and the number of taken-out products specified from the image; and
outputting the number of stocks in the sales floor.

### Supplementary Note 10

A program for causing a computer to execute processing including:
acquiring first reading information of a radio tag attached to a product, read by a first reading device provided between a backyard of a store and a sales floor of the store and an image obtained by imaging a product shelf of the sales floor;
specifying the number of stocks in the sales floor, based on the number of stocked products specified from the first reading information and the number of taken-out products specified from the image; and
outputting the number of stocks in the sales floor.

Some or all of the configurations described in Supplementary Notes 2 to 8 dependent on Supplementary Note 1 described above (stock management device) can also be dependent on Supplementary Note 9 (stock management method) and Supplementary Note 10 (program) by the same dependency relationship as Supplementary Notes 2 to 8. Some or all of the configurations described as the Supplementary Notes can be similarly dependent on not only the Supplementary Notes 1, 9 and 10, but also various pieces of hardware and software, and various recording means or systems for recording software without departing from the above-described example embodiments.

1. A stock management device comprising:
one or more memories storing instructions; and
one or more processors configured to execute the instructions to:
acquire first reading information of a radio tag attached to a product, the first reading information being read by a first reading device provided between a backyard of a store and a sales floor of the store, acquire an image obtained by imaging a product shelf of the sales floor;
specify the number of stocks in the sales floor, based on the number of stocked products specified from the first reading information and the number of taken-out products specified from the image; and
output the number of stocks in the sales floor.

2. The stock management device according to claim 1, wherein the one or more processors are further configured to execute the instructions to:
specify the number of lost products, based on a sales volume of the product and the number of taken-out products.

3. The stock management device according to claim 2, wherein the one or more processors are configured to execute the instructions to:
specify the number of lost products, based on the sales volume and the number of taken-out products specified based on the image for which a predetermined time or longer has elapsed after being captured.

4. The stock management device according to claim 2, wherein the one or more processors are configured to execute the instructions to:
output the number of lost products, to a terminal device used by an employee of the store.

5. The stock management device according to claim 1, wherein the one or more processors are further configured to execute the instructions to:
specify the number of stocks in the backyard, based on the number of arrived products and the number of stocked products.

6. The stock management device according to claim 1, wherein the one or more processors are further configured to execute the instructions to:
acquire third reading information of the radio tag, the third reading information being read by a third reading device provided at a loading entrance between the backyard and outside of the store; and
specify the number of arrived products, based on the third reading information.

7. The stock management device according to claim 1, wherein the one or more processors are further configured to execute the instructions to:
acquire second reading information of the radio tag, the second reading information being read by a second reading device provided in the backyard; and
further specify the number of stocks in the backyard, based on the second reading information.

8. The stock management device according to claim 1, wherein the one or more processors are further configured to execute the instructions to:
detect location of the product, at a timing according to a timing when the number of stocks in the sales floor changes.

9. A stock management method, executed by a computer, comprising:
acquiring first reading information of a radio tag attached to a product, the first reading information being read by a first reading device provided between a backyard of a store and a sales floor of the store, and acquire an image obtained by imaging a product shelf of the sales floor;
specifying the number of stocks in the sales floor, based on the number of stocked products specified from the first reading information and the number of taken-out products specified from the image; and
outputting the number of stocks in the sales floor.

10. A non-transitory recording medium recording program for causing a computer to execute processing comprising:
acquiring first reading information of a radio tag attached to a product, the first reading information being read by a first reading device provided between a backyard of a store and a sales floor of the store, and acquire an image obtained by imaging a product shelf of the sales floor;
specifying the number of stocks in the sales floor, based on the number of stocked products specified from the first reading information and the number of taken-out products specified from the image; and
outputting the number of stocks in the sales floor.
